(19) United States
(12) Patent Application Publication
(10) Pub. No.: US 2025/0319440 A1
(43) Pub. Date: Oct. 16, 2025

(54) ELECTRODIALYSIS CELL AND METHOD FOR LITHIUM SEPARATION

(71) Applicant: University of Massachusetts, Westborough, MA (US)

(72) Inventors: Weile Yan, Lexington, MA (US); Mythreyi Sivaraman, Somerville, MA (US)

(21) Appl. No.: 19/172,820

(22) Filed: Apr. 8, 2025

Related U.S. Application Data
(60) Provisional application No. 63/634,625, filed on Apr. 16, 2024.

(51) Int. Cl. B01D 61/42; B01D 61/46; B01J 39/19; H01M 10/0525; H01M 10/54

(52) U.S. Cl. CPC B01D 61/422; B01D 61/463; B01J 39/19; B01D 2325/42; H01M 10/0525; H01M 10/54

(57) ABSTRACT

An electrodialysis cell comprises an alternating arrangement of a surface modified cation exchange membrane and an anion exchange membrane. The surface modified cation exchange membrane is lithium selective, and the electrodialysis cell can be particularly useful for recovering lithium or other metals from spent lithium ion batteries or natural salt brines.

### CROSS-REFERENCE TO RELATED APPLICATION

This application claims priority to U.S. Provisional Application No. 63/634,625, filed Apr. 16, 2024, the contents of which are hereby incorporated by reference in their entirety.

### BACKGROUND

The mainstream recycling process in use for lithium ion battery (LIB) recyclers starts with crushing or grinding of waste batteries (also referred to as “end-of-life batteries”) in an inert gas environment. This is followed by size screening, producing two major streams, the fine particulates characterized by its black color known as the black mass and the coarse fraction of metal foils and polymers. Black mass includes electrode coatings, graphite, and binders, among which the most valuable component is the cathode coatings (containing high levels of cobalt and nickel) and lithium. The recycling industry uses either pyrometallurgical or hydrometallurgical methods to extract cobalt and nickel from black mass. Lithium is not recovered and is discharged in a liquid or solid form along with other waste products.

Another major source of lithium is natural salt brines. It is estimated that approximately two thirds of lithium sources exist in salt lake brines. Current methods for extracting lithium from brine involve solar evaporation or solvent extraction. Solar evaporation entails a long production cycle and the efficiency of solvent extraction is affected by the presence of magnesium at elevated concentrations due to poor separation of lithium and magnesium by existing solvent formulations.

The price of lithium minerals on the commodity market has increased by more than 400% since 2020 due to soaring demand driven by the electric vehicle (EV) market and a crunch in the supply chain. It would therefore be desirable to provide an improved method for recovering lithium selectively and efficiently.

### BRIEF SUMMARY

An electrodialysis cell comprises: a positive electrode compartment; a negative electrode compartment; and a stack of ion exchange membranes disposed between the positive electrode compartment and the negative electrode compartment; wherein the stack of ion exchange membranes comprises at least one cation exchange membrane and at least one anion exchange membrane in an alternating arrangement; and wherein the at least one cation exchange membrane is a surface-modified cation exchange membrane comprising compound comprising a quaternary ammonium group disposed on at least a portion of a surface of the cation exchange membrane.

A method of making a surface-modified cation exchange membrane comprises contacting a cation exchange membrane with a compound comprising a quaternary ammonium group to provide the surface-modified cation exchange membrane.

A method for separation of lithium from a lithium-rich feed solution comprises providing a feed stream comprising lithium to the electrodialysis cell; providing a carrier solution to the electrodialysis cell; and applying an electric current between the positive electrode and the negative electrode to effect electrodialysis to provide a lithium-rich stream and a lithium-depleted stream.

These and other aspects are described in detail below.

### BRIEF DESCRIPTION OF THE DRAWINGS

The following figures represent exemplary embodiments.

FIG. 1 shows process flow of lithium recovery from battery black mass (left), and a schematic of the electrolytic separator according to the present disclosure (right), wherein a Li-selective cation exchange membrane is indicated by the central dashed line.

FIG. 2 shows concentration profiles of ions in the feed chamber and receiving chamber, respectively, during electrodialytic separation of battery black mass leachate using commercial and modified membranes.

FIG. 3 shows concentration profiles of ions in the feed and receiving chambers during electrodialysis separation of a simulated lithium brine using commercial and modified membranes.

FIG. 4 shows a comparison of Li/Co selectivity (or separation factor) of commercial membrane (PCSK) and lab modified membranes (modified #50). Stack potential=3.0 volts (V). Initial concentrations of Li, Co, Ni are 20, 10, and 10 millimolar (mM), respectively, in the feed.

### DETAILED DESCRIPTION

There has been much research and development pertaining to use of ion-specific adsorbents or proprietary solvents to do selective separation. See, e.g., Li et al., Membrane-based technologies for lithium recovery from water lithium resources: A review. Journal of Membrane Science, 2019. Electrodialysis is a different technique and has the advantage of high throughput, low consumption of chemicals, and amenability to scale-up, as the process is modular and can be expanded in parallel or in series to increase throughput or purity of the product. Its ability to directly tap into renewable energy sources such as low-voltage DC is another advantage. Conventional electrodialysis does not allow preferential extraction of lithium ions among other electrolytes, nor does not it offer a way to adjust the selectivity for lithium or other ions of interest. The present inventors have discovered new methods to produce cation exchange membranes that, when used in an electrodialysis unit, preferentially move lithium from the feed to the carrier solution amidst other ions in the feed. In a particularly advantageous feature, membranes with customized ion selectivity can be provided, as the present disclosure does not require the synthesis of membranes from scratch. The selectivity can be modulated by modifying the surface of the existing membranes as detailed hercin.

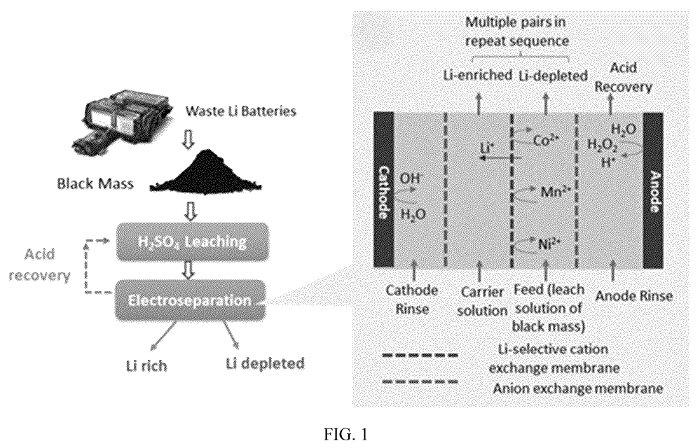

Accordingly, disclosed herein is a membrane-enabled electrodialytic (ED) cell and methods for separation of lithium. The present inventors have advantageously discovered that the disclosed electrodialysis method can be particularly useful for lithium recycling. The electrodialysis cell is built upon an electrodialysis method for metal ion separation, but with innovations to the membrane chemistry to make the process suitable for Li recycling, as illustrated schematically in FIG. 1.

An aspect of the present disclosure is an electrodialysis cell comprising a stack of ion exchange membranes disposed between a positive electrode compartment and a negative electrode compartment, wherein the stack of ion exchange membranes comprises at least one cation exchange membrane and at least one anion exchange membrane in an alternating arrangement. The stack sequence (i.e., the specific arrangement of the cation exchange and anion exchange membranes) can vary depending on the particular application. It is also noted that flow arrangement through the cell can vary based on the application.

In a specific aspect, the electrodialytic cell can comprise a positive electrode compartment; a first anion exchange membrane adjacent to the positive electrode compartment; a first cell adjacent to the first anion exchange membrane configured to receive a carrier solution; a surface-modified cation exchange membrane adjacent to the first cell on a side opposite the first anion exchange membrane; a second cell adjacent to the surface-modified cation exchange membrane configured to receive a feed solution; a second anion exchange membrane adjacent to the second cell on a side opposite the surface-modified cation exchange membrane; and a negative electrode compartment. The surface-modified cation exchange membrane comprises a compound comprising a quaternary ammonium group disposed on at least a portion of a surface of the cation exchange membrane. The surface-modified cation exchange membrane can be lithium selective. In an aspect, the anion exchange membrane may include a surface modification, for example to provide selectivity for a particular ion.

There are many possible arrangements of the compartments in the electrolytic separator, all of which are contemplated by the present disclosure. In some aspects, multiple pairs (e.g., up to 20) of the central two compartments may be included in a single device.

FIG. 1 shows a schematic illustration of a configuration of the electrodialysis cell according to an aspect of the present disclosure. Specifically, FIG. 1 shows a 4-chamber configuration, where the two end chambers house the positive and negative electrodes, respectively, with electrode rinse solution flowing through the chambers. The four-chamber configuration shown in FIG. 1 represents a non-limiting embodiment as to the configuration. The middle two compartments are separated by a cation exchange membrane. Of the two, the compartment on the side of the cation exchange membrane closer to the positive electrode is the diluate compartment (e.g., where feed solution may be supplied), and the one on the opposite side of the cation exchange membrane is the concentrate compartment (e.g., where carrier solution may be supplied). A device may contain multiple (e.g., up to 20) repeating units of the middle compartments. The membranes at the two ends of the stack can be either anion or cation exchange membranes, the choice of which affects the stacking sequence of the middle membranes as will be recognized by one of skill in the art.

The chemistry of the membrane (specifically, the cation exchange membrane (CEM)) can influence the separation performance. In an aspect, the cation exchange membrane can comprise a sulfonic acid polymer membrane, although many other commercially available cation exchange membranes may also be suitable for use in the present disclosure.

The cation exchange membrane is surface modified to include quaternary ammonium groups disposed on at least a portion of a surface of the cation exchange membrane. There are many approaches to membrane surface modification. For example, surface modification can be achieved by an electrodeposition process. The present inventors have found that electrochemical deposition can provide improved performance and stability relative to other modification procedures such as dip coating or flow coating. Furthermore, the coating of multiple layers comprising multiple types of polyelectrolytes is not required. One-step electrochemical deposition methods also allow for in situ regeneration, which may not be feasible with other methods. In an exemplary electrodeposition method, the cation exchange membrane can be contacted with a compound comprising a quaternary ammonium group by providing an electrodialysis cell comprising the cation exchange membrane, and introducing a solution comprising the compound comprising a quaternary ammonium group to the electrodialysis cell to provide the surface-modified cation exchange membrane in situ. In an aspect, the cell comprising the membrane and solution can be subjected to an applied electric field at a voltage of 0.1 to 4 volts per cell pair and for a time of up to 120 minutes. In an aspect, the solution comprising the compound comprising a quaternary ammonium group can be present in the solution in an amount of 0.1 to 20 grams per liter. Other techniques are also contemplated by the present disclosure.

In an aspect, the surface modification can comprise a thin, uniform layer of the desired modifier(s) deposited on the surface. Overloading the surface can create a transport barrier, which in turn can reduce the overall ion mobility and current efficiency. In an aspect, the surface-modified cation exchange membrane can have a loading of 0.01 to 5 milligrams of modifier(s) per square centimeter (mg/cm²). Within this range, the surface-modified cation exchange membrane can have a loading of at least 0.05 mg/cm², or at least 0.1 mg/cm², or at least 0.5 mg/cm², or at least 1 mg/cm². Also within this range, the surface-modified cation exchange membrane can have a loading of at most 4.5 mg/cm², or at most 4 mg/cm², or at most 3.5 mg/cm², or at most 3 mg/cm², or at most 2.5 mg/cm², or at most 2 mg/cm².

Suitable surface modifiers comprising a quaternary ammonium group are not particularly limited provided that the surface modifier can provide the desired amount of quaternary ammonium groups to the surface of the membrane. In an aspect, the compound comprising the quaternary ammonium group can be a polymer comprising a plurality of repeating units comprising a quaternary ammonium groups. The polymer can preferably be a water soluble polymer. In an aspect, the polymer can have a molecular weight of 5,000 to 800,000 grams per mole, or 10,000 to 500,000 grams per mole, or 50,000 to 500,000 grams per mole, or 75,000 to 500,000 grams per mole, or 100,000 to 500,000 grams per mole, or 100,000 to 400,000 grams per mole, or 100,000 to 350,000 grams per mole, or 100,000 to 300,000 grams per mole. Exemplary quaternary ammonium polymers can include, but are not limited to, homopolymers or copolymers of diallyldialkylammonium salt (e.g., diallyldimethylammonium chloride), 3-(meth) acrylamido alkylammonium chloride (e.g., 3-(meth) acrylamido-propyltrimethylammonium chloride, 3-(meth) acrylamido-3,3-dimethylpropyltrimethylammonium chloride), vinylbenzyltrialkyl ammonium chloride (e.g., vinylbenzyltrimethylammonium chloride), allylamine, and the like, or a combination thereof. In a specific aspect, the quaternary ammonium polymer can be poly (diallyldimethylammonium chloride) (polyDADMAC). In some aspects, a single polymer may be used to provide the surface modification. In some aspects a combination of any of the foregoing polymers may be used.

It is noted that chloride salts are specifically mentioned in the foregoing examples, however other counterions are contemplated by the present disclosure (e.g., ammonium chloride, ammonium fluoride, ammonium bromide, ammonium iodine, ammonium bisulfate, ammonium alkyl sulfate, ammonium dihydrogen phosphate, ammonium hydrogen alkyl phosphate, ammonium dialkyl phosphate, and the like). For example, the diallyl dimethyl ammonium salts as described herein include, but are not limited to: diallyl dimethyl ammonium chloride (DADMAC), diallyl dimethyl ammonium fluoride, diallyl dimethyl ammonium bromide, diallyl dimethyl ammonium iodine, diallyl dimethyl ammonium bisulfate, diallyl dimethyl ammonium alkyl sulfate, diallyl dimethyl ammonium dihydrogen phosphate, diallyl dimethyl ammonium hydrogen alkyl phosphate, diallyl dimethyl ammonium dialkyl phosphate, and combinations thereof. In some aspects, the ammonium salt can preferably be ammonium chloride.

Without wishing to be bound by theory, it is believed that imparting a positive charge can impede the transport of multivalent cations such as Mg²⁺, Ca²⁺ or Ni²⁺, while allowing monovalent cations, such as lithium, to pass.

The first and second anion exchange membranes can be the same or different, and many different commercially available anion exchange membranes may be suitable. In an aspect, the anion exchange membranes can comprise positively charged groups, for example a plurality of quaternary ammonium cations. In an aspect, the anion exchange membranes can be unmodified (i.e., used as received).

In some aspects, poly (styrene sulfonate) is not used to modify any ion exchange membrane in the electrodialysis cell of the present disclosure.

In a specific aspect, the electrodialysis cell according to the present disclosure comprises the positive electrode compartment; a first anion exchange membrane adjacent to the positive electrode compartment; a first cell adjacent to the first anion exchange membrane configured to receive a carrier solution; a surface-modified cation exchange membrane adjacent to the first cell on a side opposite the first anion exchange membrane; a second cell adjacent to the surface-modified cation exchange membrane configured to receive a feed solution; a second anion exchange membrane adjacent to the second cell on a side opposite the surface-modified cation exchange membrane; and the negative electrode compartment.

A method of making a surface-modified cation exchange membrane is also provided herein. In an aspect, the method comprises contacting a cation exchange membrane with a compound comprising a quaternary ammonium group to provide the surface-modified cation exchange membrane. The contacting can be under conditions effective to provide the surface-modified cation exchange membrane. For example, contacting the cation exchange membrane with a compound comprising a quaternary ammonium group can include providing an electrodialysis cell comprising the cation exchange membrane, and introducing a solution comprising the compound comprising a quaternary ammonium group to the electrodialysis cell to provide the surface-modified cation exchange membrane in situ. The cell with the membrane and solution can be subjected to an applied electric field at a voltage of 0.1 to 4 volts per cell pair and for a time of up to 120 minutes. In an aspect, the solution comprises the compound comprising a quaternary ammonium group in an amount of 0.1 to 20 grams per liter.

A method for separation of lithium from a lithium-rich feed solution is also provided by the present disclosure. For example, the method can comprise providing a feed stream comprising lithium to the electrodialysis cell; providing a carrier solution to the electrodialysis cell; and applying an electric current between the positive electrode and the negative electrode to effect electrodialysis and provide a lithium-rich stream and a lithium depleted stream.

As shown in FIG. 1, the electrodialysis cell comprises a positive electrode compartment containing a suitable positive electrode and a negative electrode compartment containing a suitable negative electrode, wherein the positive electrode compartment and the negative electrode compartment are separated from each other by at least one surface modified cation exchange membrane in an alternating arrangement with at least one anion exchange membrane. Additional membranes (i.e., cation exchange, anion exchange, or both) may be present provided that they are arranged in an alternating fashion. The alternating anion and cation exchange membranes form alternating concentrate and diluate cells.

A feed solution containing lithium can be fed into the diluate cell(s) of the electrodialysis unit. If necessary, the feed solution can be adjusted to a predetermined value of the pH or oxidation state. The feed solution can be, for example, an aqueous solution that may also contain organic components. In an aspect, the feed solution is a solution comprising recycled lithium ion battery components. In an aspect, the feed solution can comprise lithium and one or more of cobalt, manganese, or nickel. A suitable direct current is applied between the electrodes in the electrode compartments of the unit, and the value of the current is sufficient to effect the separation by electrodialysis. Lithium can migrate through the surface modified cation exchange membrane from the solution in the diluate cells into a carrier solution in the adjacent concentrate cells. Other non-lithium species (e.g., nickel, cobalt, manganese, calcium, magnesium, etc.) substantially remain in the diluate cells. During electrodialysis, the circulating solution in the concentrate cells becomes concentrated in lithium, and the circulating solution in the diluate cells becomes depleted in lithium. A solution is withdrawn from the concentrate cells that is concentrated in lithium and a solution is withdrawn from the diluate cells that is depleted in lithium.

The electrode compartments are preferably rinsed with appropriate, circulating rinse solutions, or a common rinse solution. In an aspect, the electrode compartments can be rinsed with water optionally including suitable electrolytes. The electrodialysis may be carried out in single or multi-stage to effect the desired degree of separation and concentration.

The current applied to the electrodes is controlled such that the membrane current density (applied current per membrane surface area) is sufficient to effect the desired separation of species but minimizes water splitting. In an aspect, the current can be equivalent to a current density of 10 to 500 A/m², the particular value selected being a function of the concentrations of species in the feed solution. Below about 10 A/m², the ionic transfer rate can be too low and above about 500 A/m² there may not be enough ionized species to replenish the ions transferred from the diffusion layer at the membrane and, as a result, water splitting and/or loss of permselectivity may occur to an undersirable extent. Water splitting and permselectivity loss can be substantially obviated when operating with current densities in the range of 10 to 500 A/m², preferably about 50 to 350 A/m² under conditions of turbulence in the concentrate and diluate cells. In an aspect, the electrodialytic cell can be operated at an applied voltage of about 0.5 to 5 volts per cell pair.

There are system-level parameters that can influence the ion separation efficiency in an ED process, including current density, fluid flow rates, feed chemistry (pH, total TDS, ionic composition), and the like, and combinations thereof. These factors can impact the mobility of all ions (to varying degrees), but they do not reverse selectivity preference, nor do they offer a systematic flexible approach to tune selectivity for a specific set of ions. In an advantageous feature, the system comprising the surface-modified membrane can be regenerated in situ. For example, in an aspect, the method of conducting the separation of lithium from the feed stream can further comprise introducing a solution comprising the compound comprising a quaternary ammonium group to the electrodialysis cell to provide a regenerated surface-modified cation exchange membrane.

Accordingly, an improvement in electrodialytic cells, particularly for the separation of lithium from a feed stream, is provided by the devices and methods of the present disclosure.

### EXAMPLES

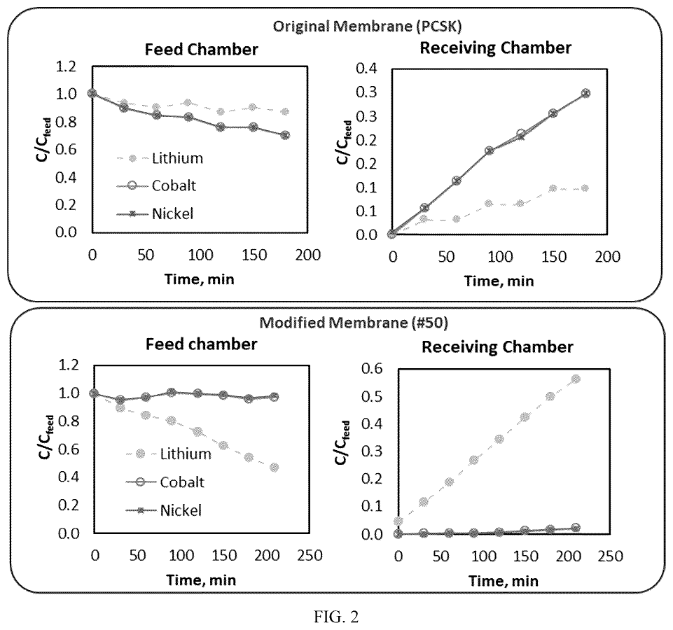

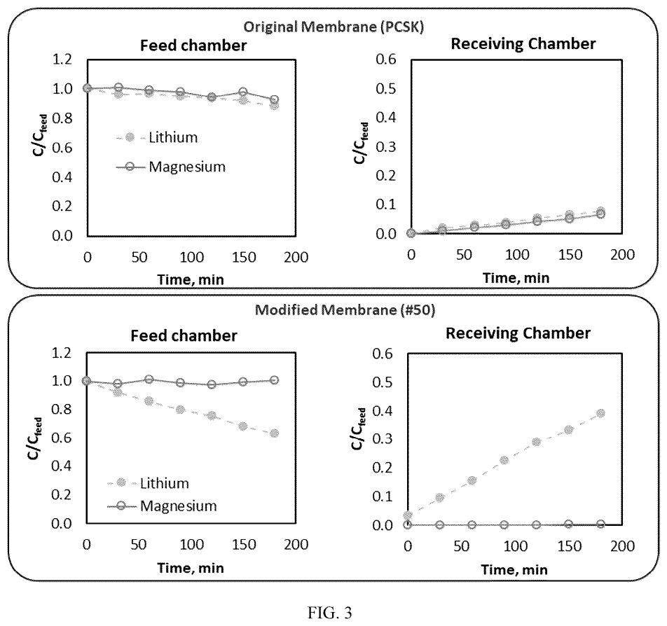

Shown in FIG. 2 and FIG. 3 are the concentration trends of various metal ions in the feed chamber when different cation exchange membranes were used in the separation process. The process used an off-the-shelf CEM (PCSK™) as a comparative example, and a modified PCSK membrane (“#50”) according to an aspect of the present disclosure. As shown, cobalt (Co) (FIG. 2) and magnesium (Mg) (FIG. 3) were extracted preferentially from the feed when the original PCSK™ was used. The selectivity was reversed when the modified PSCK (“#50”) membrane was used, and Li was preferentially extracted from the feed.

Membranes according to the present disclosure were prepared by depositing poly (diallyldimethylammonium chloride) onto a PCSK membrane. Only one side of the membrane was modified (i.e., the side of the membrane that faces the feed solution). A detailed description of the preparation is provided below.

A PCSK membrane as purchased was conditioned in a salt solution for 4 days. The membrane was stacked with spacers and anionic exchange membranes in an alternating fashion to provide the electrodialysis (ED) device. The ED stack was set up in a 4-chamber configuration. The receiving/concentrate chamber used 500 milliliters of 0.01 M HNO₃, and the electrode rinse chamber used 1 liter of 0.05 M NaNO₃ solution. For the feed/diluate chamber, a poly (diallyldimethylammonium chloride) solution was prepared at a concentration between 1 to 20 grams per liter. The reservoirs of each of the feed, receiving, and electrode rinse solutions were connected with the respective chambers. The pump was turned on and the system was circulated for 5 minutes. The ED power supply was turned on and the potential was set to 3 volts. The poly (diallyldimethylammonium chloride) solution was circulated for 60 minutes. The current and voltage was monitored. The system was powered down after the desired time and the surface-modified membrane was ready to use.

Separation using the membranes of the present disclosure is shown in FIGS. 2 and 3 (bottom portions). It can be seen from FIG. 2 and FIG. 3 that Li was extracted preferentially from the feed with improved lithium selectivity compared to the commercial membranes shown in the top portions of both FIG. 2 and FIG. 3.

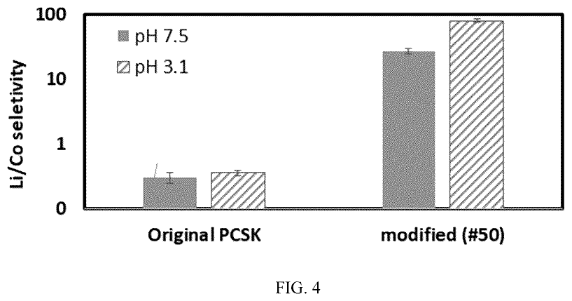

FIG. 4 further shows the lithium vs. cobalt selectivity for PCSK as received and PCSK modified with poly (diallyldimethylammonium chloride) (“modified #50”). The modified membrane was prepared according to the procedure described above.

The technological advantage of being able to recover Li selectively relative to other ions is that it generates relatively pure Li-enriched stream for subsequent processing. Most importantly, the technology described herein demonstrates that tailoring the membrane chemistry can provide a way to extract the ion of interest, which is not restricted to Li, from a complex mixture of background ions. A significant improvement is therefore provided by the present disclosure.

This disclosure further encompasses the following aspects.
Aspect 1: An electrodialysis cell comprising: a positive electrode compartment; a negative electrode compartment; and a stack of ion exchange membranes disposed between the positive electrode compartment and the negative electrode compartment; wherein the stack of ion exchange membranes comprises at least one cation exchange membrane and at least one anion exchange membrane in an alternating arrangement; and wherein the at least one cation exchange membrane is a surface-modified cation exchange membrane comprising compound comprising a quaternary ammonium group disposed on at least a portion of a surface of the cation exchange membrane.
Aspect 2: The electrodialysis cell of aspect 1, wherein the surface-modified cation exchange membrane is lithium selective.
Aspect 3: The electrodialysis cell of any of aspects 1 to 2, wherein the cation exchange membrane comprises a sulfonic acid polymer membrane.
Aspect 4: The electrodialysis cell of any of aspects 1 to 3, wherein the surface-modified cation exchange membrane comprises the quaternary ammonium group in an amount of 0.01 to 5 mg/cm².
Aspect 5: The electrodialysis cell of any of aspects 1 to 4, wherein the compound comprising the quaternary ammonium group is a polymer comprising a plurality of repeating units comprising a quaternary ammonium groups.
Aspect 6: The electrodialysis cell of aspect 5, wherein the polymer comprising a plurality of repeating units comprising a quaternary ammonium groups comprises poly (diallyldimethylammonium chloride).
Aspect 7: The electrodialysis cell of aspect 6 or 7, wherein the polymer comprising a plurality of repeating units comprising a quaternary ammonium groups has a molecular weight of 5,000 to 800,000 grams per mole.
Aspect 8: The electrodialysis cell of any of aspects 1 to 7, wherein the first and the second anion exchange membrane are the same or different.
Aspect 9: The electrodialysis cell of any of aspects 1 to 8, wherein the first and the second anion exchange membrane each independently comprise quaternary ammonium cations.
Aspect 10: The electrodialysis cell of aspect 1, comprising the positive electrode compartment; a first anion exchange membrane adjacent to the positive electrode compartment; a first cell adjacent to the first anion exchange membrane configured to receive a carrier solution; a surface-modified cation exchange membrane adjacent to the first cell on a side opposite the first anion exchange membrane; a second cell adjacent to the surface-modified cation exchange membrane configured to receive a feed solution; a second anion exchange membrane adjacent to the second cell on a side opposite the surface-modified cation exchange membrane; and the negative electrode compartment.
Aspect 11: A method of making a surface-modified cation exchange membrane, the method comprising: contacting a cation exchange membrane with a compound comprising a quaternary ammonium group to provide the surface-modified cation exchange membrane.
Aspect 12: The method of aspect 11, wherein contacting the cation exchange membrane with a compound comprising a quaternary ammonium group comprises providing an electrodialysis cell comprising the cation exchange membrane, and introducing a solution comprising the compound comprising a quaternary ammonium group to the electrodialysis cell to provide the surface-modified cation exchange membrane in situ.
Aspect 13: The method of aspect 12, wherein the contacting is at a voltage of 0.1 to 4 volts per cell pair and for a time of up to 120 minutes.
Aspect 14: The method of aspect 12 or 13, wherein the solution comprises the compound comprising a quaternary ammonium group in an amount of 0.1 to 20 grams per liter.
Aspect 14: A method for separation of lithium from a lithium-rich feed solution, the method comprising: providing a feed stream comprising lithium to the electrodialysis cell of any of aspects 1 to 10; providing a carrier solution to the electrodialysis cell of any of aspects 1 to 10; and applying an electric current between the positive electrode and the negative electrode to effect electrodialysis to provide a lithium-rich stream and a lithium-depleted stream.
Aspect 16: The method of aspect 15, further comprising regenerating the surface-modified cation exchange membrane in situ by introducing a solution comprising the compound comprising a quaternary ammonium group to the electrodialysis cell to provide a regenerated surface-modified cation exchange membrane.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Each range disclosed herein constitutes a disclosure of any point or sub-range lying within the disclosed range.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). “Or” means “and/or”.

1. An electrodialysis cell comprising:
a positive electrode compartment;
a negative electrode compartment; and
a stack of ion exchange membranes disposed between the positive electrode compartment and the negative electrode compartment;
wherein the stack of ion exchange membranes comprises at least one cation exchange membrane and at least one anion exchange membrane in an alternating arrangement; and
wherein the at least one cation exchange membrane is a surface-modified cation exchange membrane comprising compound comprising a quaternary ammonium group disposed on at least a portion of a surface of the cation exchange membrane.

2. The electrodialysis cell of claim 1, wherein the surface-modified cation exchange membrane is lithium selective.

3. The electrodialysis cell of claim 1, wherein the cation exchange membrane comprises a sulfonic acid polymer membrane.

4. The electrodialysis cell of claim 1, wherein the surface-modified cation exchange membrane comprises the quaternary ammonium group in an amount of 0.01 to 5 mg/cm².

5. The electrodialysis cell of claim 1, wherein the compound comprising the quaternary ammonium group is a polymer comprising a plurality of repeating units comprising a quaternary ammonium groups.

6. The electrodialysis cell of claim 5, wherein the polymer comprising a plurality of repeating units comprising a quaternary ammonium groups comprises poly (diallyldimethylammonium chloride).

7. The electrodialysis cell of claim 6, wherein the polymer comprising a plurality of repeating units comprising a quaternary ammonium groups has a molecular weight of 5,000 to 800,000 grams per mole.

8. The electrodialysis cell of claim 1, wherein the first and the second anion exchange membrane are the same or different.

9. The electrodialysis cell of claim 1, wherein the first and the second anion exchange membrane each independently comprise quaternary ammonium cations.

10. The electrodialysis cell of claim 1, comprising
the positive electrode compartment;
a first anion exchange membrane adjacent to the positive electrode compartment;
a first cell adjacent to the first anion exchange membrane configured to receive a carrier solution;
a surface-modified cation exchange membrane adjacent to the first cell on a side opposite the first anion exchange membrane;
a second cell adjacent to the surface-modified cation exchange membrane configured to receive a feed solution;
a second anion exchange membrane adjacent to the second cell on a side opposite the surface-modified cation exchange membrane; and
the negative electrode compartment.

11. A method of making a surface-modified cation exchange membrane, the method comprising:
contacting a cation exchange membrane with a compound comprising a quaternary ammonium group to provide the surface-modified cation exchange membrane.

12. The method of claim 11, wherein contacting the cation exchange membrane with a compound comprising a quaternary ammonium group comprises providing an electrodialysis cell comprising the cation exchange membrane, and introducing a solution comprising the compound comprising a quaternary ammonium group to the electrodialysis cell to provide the surface-modified cation exchange membrane in situ.

13. The method of claim 12, comprising applying a voltage of 0.1 to 4 volts per cell pair and for a time of up to 120 minutes.

14. The method of claim 12, wherein the solution comprises the compound comprising a quaternary ammonium group in an amount of 0.1 to 20 grams per liter.

15. A method for separation of lithium from a lithium-rich feed solution, the method comprising:
providing a feed stream comprising lithium to the electrodialysis cell of claim 1;
providing a carrier solution to the electrodialysis cell; and
applying an electric current between the positive electrode and the negative electrode to effect electrodialysis to provide a lithium-rich stream and a lithium-depleted stream.

16. The method of claim 15, further comprising regenerating the surface-modified cation exchange membrane in situ by introducing a solution comprising the compound comprising a quaternary ammonium group to the electrodialysis cell to provide a regenerated surface-modified cation exchange membrane.
